(19) United States
(12) Patent Application Publication
(10) Pub. No.: US 2018/0332825 A1
(43) Pub. Date: Nov. 22, 2018

(54) ANIMAL MUZZLE WITH A DEFORMABLE FRAME

(71) Applicant: Stacia Cameron, San Diego, CA (US)

(72) Inventor: Stacia Cameron, San Diego, CA (US)

(21) Appl. No.: 15/601,962

(22) Filed: May 22, 2017

(51) Int. Cl. A01K 25/00

(52) U.S. Cl. CPC A01K 25/00

(57) ABSTRACT

An animal muzzle intended for use on brachycephalic breeds has a manually deformable muzzle frame bounding a frontal opening that is covered at least in part or in whole by a frontal barrier to help prevent the animal from biting. The entire muzzle frame may be manually deformable, or one or more frame segments of the muzzle frame can be rigid and joined to one or more deformable segments of the muzzle frame. An animal's owner can shape the muzzle frame to fit the animal's face to provide a comfortable fit and not obstruct the animal's eyes. The deformable muzzle frame has one or more halter attachment locations on it for attaching a halter to secure the deformable muzzle frame to the animal's head.

### TECHNICAL FIELD

The present invention is in the field of animal muzzles. More specifically animal muzzles for use on brachycephalic animals.

### SUMMARY OF THE INVENTION

A conventional animal muzzle is a device that is placed around the snout of an animal to keep it from biting or otherwise opening its mouth. Muzzles are used on untrained dogs, large or small, to prevent unwanted biting, chewing, or scavenging. They can also be used on dogs who display aggression. They can of course also be used on other animals, such as cats for example. They are often made with a velcro or other fastening device to ensure that they do not come off accidentally. Unlike the present invention described herein, conventional muzzles for dogs typically do not have a construction that has openings that give enough freedom for a dog to drink and freely pant, which can be of great importance in hot weather, while allowing the muzzle to still perform its primary function of keeping the animal from biting, chewing, or scavenging.

Brachycephalia refers to a flat and wide skull shape. In dogs, it is the opposite to the skull shape of long nosed breeds called dolichocephalia. A brachycephalic skull appears as though the skull has been compressed from front to back. Dog breeds that are brachycephalic include, by way of example and not limitation: Pug, English Bulldog, French Bulldog, Cavalier King Charles Spaniel, Boston Terrier, Shih Tzu and Pekinese. Cats are another example of a common brachycephalic animal breed.

As with other animal breeds, there is a need for brachycephalic animal breeds to be equipped with muzzles to prevent them from biting. However, conventional animal muzzles are designed to be secured to the long snout of an animal. These muzzles do not work well, or at all, on brachycephalic animal breeds which do not have a long snout. There have been prior attempts to provide muzzles for brachycephalic breeds, but these muzzle devices have shortcomings. Specifically, they typically cover the entire face of the animal obstructing the animal's vision, breathing, and/or ability to drink through the muzzle. It is an objective of the present invention to overcome such shortcomings of the prior art animal muzzles for brachycephalic animal breeds, including by way of example and limitation, domestic dogs and cats.

The present invention is an animal muzzle that incorporates a manually deformable muzzle frame bounding a frontal opening that is covered at least in part by a frontal barrier that helps prevent the animal from biting. In a preferred exemplary embodiment, the deformable muzzle frame is comprised of an inner armature constructed of a deformable material such as a plurality of strands of wire, and a pliable outer covering over such inner deformable armature that is constructed of a flexible substance which may be an elastomer material such as silicone rubber or a soft polyvinyl chloride material.

In a first exemplary embodiment, the muzzle frame may be comprised of a single segment that is uniformly deformable over the entire muzzle frame. In alternative embodiments, the deformable frame may comprise a plurality of joined segments having different deformability characteristics. For example, in a second exemplary embodiment the muzzle frame may comprise a plurality of deformable segments that have different deformability (i.e. some segments may be semi-rigid and harder to bend into a shape than other more deformable segments). In another third exemplary embodiment one or more segments of the deformable muzzle frame may be rigid, with such rigid segments of the frame not being deformable.

The use of a manually deformable frame permits an animal owner to shape and custom fit the muzzle to the face of the animal such that the muzzle when applied will comfortably fit, help prevent biting, and not cover the eyes of the animal. In preferred embodiments of the present invention the frontal barrier has at least one passageway through it to facilitate the animal being able to breath and/or drink while wearing the muzzle. A variety of different frontal barrier configurations may be used. The deformable muzzle frame has one or more halter attachment locations on it that are suitable for attaching a halter that is used to secure the muzzle frame to the animal's head.

It is further contemplated that in some embodiments the deformable muzzle of the present invention may be modular with individual components being removably attached to one another. In such embodiments frame segments, frontal barriers, and halters are capable of being removed and replaced. The ability to remove and replace individual components of the muzzle can facilitate cleaning, repairing, or replacing individual components that become dirty, worn or damaged. Similarly, an owner may be able to remove and replace an individual component with an individual component that has different ornamental or functional features.

To attach the muzzle of the present invention to a brachycephalic animal's head a person (e.g. the animal's owner) manually deforms the muzzle frame so that it conforms to the shape of the animal's face and will be well fitted to prevent the animal from biting while not covering the eyes of the animal. The deformable frame may be manually deformed while the muzzle is in place over the animal's face. Alternatively, the animal owner may deform the frame with the muzzle away from the animal, place it onto the animal to test fit, and then remove to adjust further as needed until the desired fit is achieved. Once the frame has been deformed to the desired shape and the muzzle frame has been appropriately fitted to the animal's face the muzzle is then preferably secured in place to the animal's head using a halter attached to the muzzle frame.

### BRIEF DESCRIPTION OF THE DRAWINGS

FIG. 1 is an elevated right front perspective view of a first exemplary embodiment of the present animal muzzle invention with a single segment deformable frame having a pliable mesh frontal barrier covering the frontal opening, as applied to a brachycephalic dog's head.

FIG. 2 is an elevated front perspective view of the animal muzzle of FIG. 1 without the halter prior to deformation of the deformable frame.

FIG. 3 is an elevated front perspective view of the animal muzzle of FIG. 1 with the halter attached to the frame after a manual deformation of the deformable frame.

FIG. 4 is a view of a cross-section along axis A-A′ of the muzzle frame of FIG. 2 showing the inner deformable armature and pliable outer covering.

FIG. 5 is a view of a cross-section along axis A-A′ of the muzzle frame of FIG. 3 showing the inner deformable armature and pliable outer covering.

FIG. 6 is an elevated right front perspective view of a second exemplary embodiment of the present animal muzzle invention with a multi-segment deformable frame comprising a deformable frame segment and a semi-rigid frame segment, and a pliable fabric frontal barrier covering the frontal opening with a single central passageway, as applied to a brachycephalic dog's head.

FIG. 7 is an elevated front perspective view of the animal muzzle of FIG. 6 with the halter attached to the frame prior to deformation of the deformable frame segment.

FIG. 8 is an elevated front perspective view of the animal muzzle of FIG. 6 with the halter attached to the frame after a deformation of the deformable frame segment.

FIG. 9 is a view of a cross-section along axis A-A′ of the muzzle frame of FIG. 7 showing the inner deformable armatures and pliable outer coverings of the deformable frame segment and semi-rigid frame segment, as well as the interior of the joints connecting the two frame segments.

FIG. 10 is a view of a cross-section along axis A-A′ of the muzzle frame of FIG. 8 showing the inner deformable armatures and pliable outer coverings of the deformable frame segment and semi-rigid frame segment, as well as the interior of the joints connecting the two frame segments.

FIG. 11 is an elevated right front perspective view of a third exemplary embodiment of the present animal muzzle invention with a multi-segment deformable frame comprising a deformable frame segment and a rigid frame segment, and a convex shaped rigid cage frontal barrier covering a lower portion of frontal opening, as applied to a brachycephalic dog's head.

FIG. 12 is an elevated front perspective view of the animal muzzle of FIG. 11 with the halter attached to the frame prior to deformation of the deformable frame segment.

FIG. 13 is an elevated front perspective view of the animal muzzle of FIG. 11 with the halter attached to the frame after a deformation of the deformable frame segment.

FIG. 14 is a view of a cross-section along axis A-A′ of the muzzle frame of FIG. 12 showing the inner deformable armature and pliable outer covering of the deformable frame segment, the interior of the solid rigid frame segment, and the interior of the joints connecting the deformable frame segment to the rigid frame segment.

FIG. 15 is a view of a cross-section along axis A-A′ of the muzzle frame of FIG. 13 showing the inner deformable armature and pliable outer covering of the deformable frame segment, the interior of the solid rigid frame segment, and the interior of the joints connecting the deformable frame segment to the rigid frame segment.

FIG. 16 is an elevated right front perspective view of a fourth exemplary embodiment of the present animal muzzle invention with a multi-segment deformable frame comprising a deformable frame segment and a rigid frame segment, and a pliable convex shaped metal mesh frontal barrier covering the frontal opening, as applied to a brachycephalic dog's head.

FIG. 17 is an elevated perspective view along axis X-X′ of FIG. 16 showing a section of a male end of the deformable frame segment adjacent to a section of a female end of the rigid frame segment prior to them being joined together to form a crimped joint.

FIG. 18 is a view of a cross section along axis X-X′ of FIG. 16 showing the interior of the crimped joint formed between the deformable frame segment and the rigid frame segment of the animal muzzle frame of FIG. 16.

FIG. 19 is an elevated perspective view along axis X-X′ of FIG. 16 of the crimped joint formed between deformable frame segment and rigid frame segment of the animal muzzle frame of FIG. 16.

FIG. 20 is left side view of a fifth exemplary embodiment of the present animal muzzle invention with a multi-segment deformable frame comprising a deformable frame segment and a rigid frame segment, and a convex shaped rigid cage frontal barrier covering the lower portion of the frontal opening, as applied to a brachycephalic dog's head with a halter having a lead strap and collar.

FIG. 21 is an elevated left side perspective view of a frontal barrier having attached frontal barrier ties, with the frontal barrier being positioned in front of a single segment deformable frame that it is to be removably attached to.

FIG. 22 is an elevated left side perspective view of the frontal barrier of FIG. 21 removably attached to the deformable frame of FIG. 21 with the frontal barrier ties.

### DETAILED DESCRIPTION OF THE INVENTION

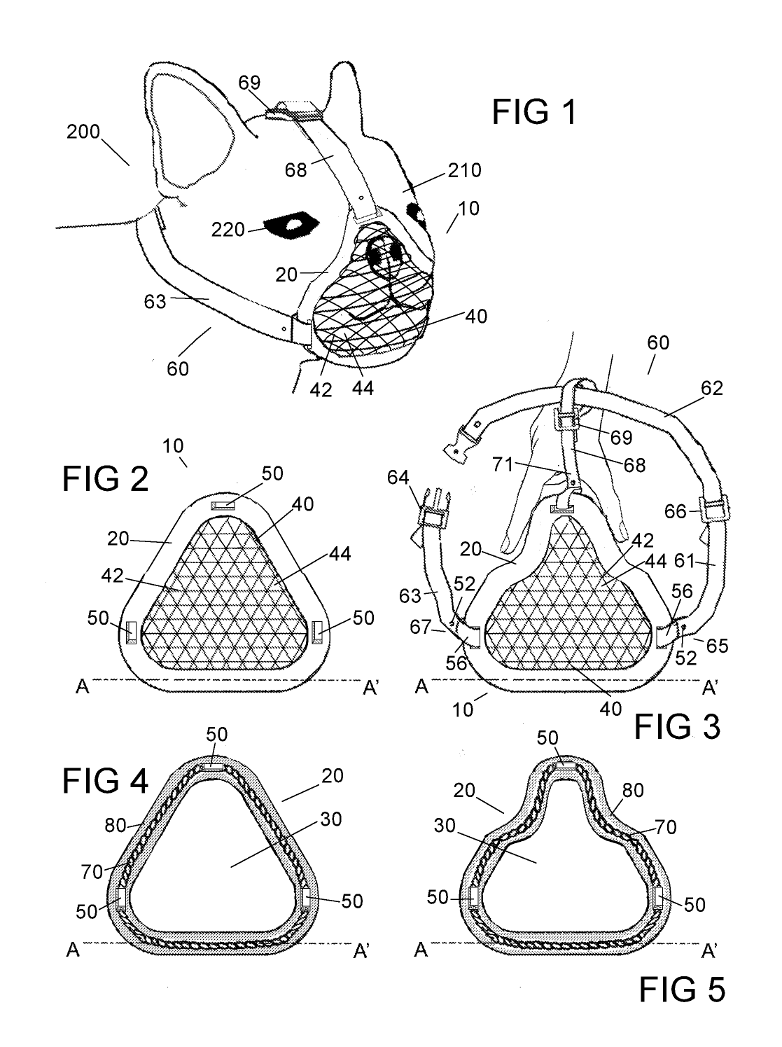

Referring to FIGS. 1-3 a first exemplary embodiment of the present invention for an animal muzzle 10 with a deformable frame 20 is shown. Single segment manually deformable frame 20 bounds a frontal opening 30. Frame 20 should be of sufficient size such that the area of frontal opening 30 is sufficient to cover the mouth and nose of the animal that the muzzle is intended to be applied to. Frontal barrier 40 is attached to frame 20 and in the illustrated embodiment of FIGS. 1-3 is covering frontal opening 30.

FIGS. 4-5 illustrate in cross-section the interior along axis A-A′ of single segment frame 20 for the embodiment shown in FIGS. 2 and 3 respectively. As shown deformable frame 20 comprises an inner deformable armature 70 that is covered by a pliable outer covering 80. Inner deformable armature 70 may be comprised of one or more deformable metallic wire strands that can be deformed into a position and/or shape through one or more forces applied by a person manually and that will retain such position or shape once the person ceases applying manual force. Examples of manually deformable armatures may be found in U.S. Pat. Nos. 3,624,691; 5,762,531; 5,800,242; 6,217,406, and the disclosures of each of these patents are hereby fully incorporated by reference. Pliable outer covering 80 comprises a flexible material which may, by way of example and not limitation, be an elastomer material like silicone rubber, a soft polyvinyl chloride material, or a fabric. Any elasticity of pliable outer covering 80 should be minimal such that the elastic forces of pliable outer covering 80 do not prevent inner deformable armature 70 from maintaining the shape or position it is deformed into.

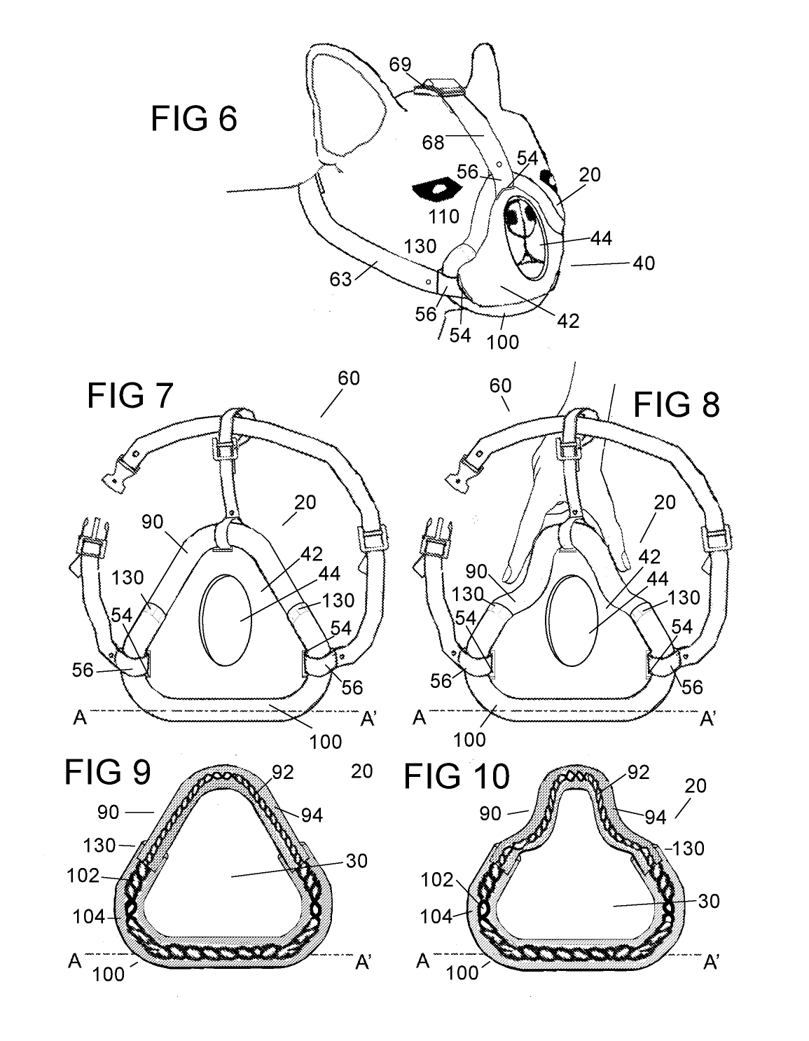

FIGS. 6-8 illustrate a second exemplary embodiment where frame 20 is has a plurality of segments that comprise a deformable segment 90 and a semi-rigid segment 100. FIGS. 9-10 illustrate in cross-section the interior along axis A-A′ of frame 20 for the embodiment shown in FIGS. 7 and 8. As shown deformable frame segment 90 comprises an inner deformable armature 92 that is covered by a pliable outer covering 94. Semi-rigid frame segment 100 comprises an inner deformable armature 102 that is covered by a pliable outer covering 104. Deformable segment 90 requires less manual force to deform into a shape and position than the manual force that must be applied to semi-rigid segment 100. This is accomplished by inner deformable armature 92 being less rigid than inner deformable armature 102. This may be accomplished, by way of example and not limitation, by the one or more metallic wire strands of inner deformable armature 92 of deformable segment 90 being thinner than the one or more metallic wire strands of inner deformable armature 94 of semi-rigid segment 100.

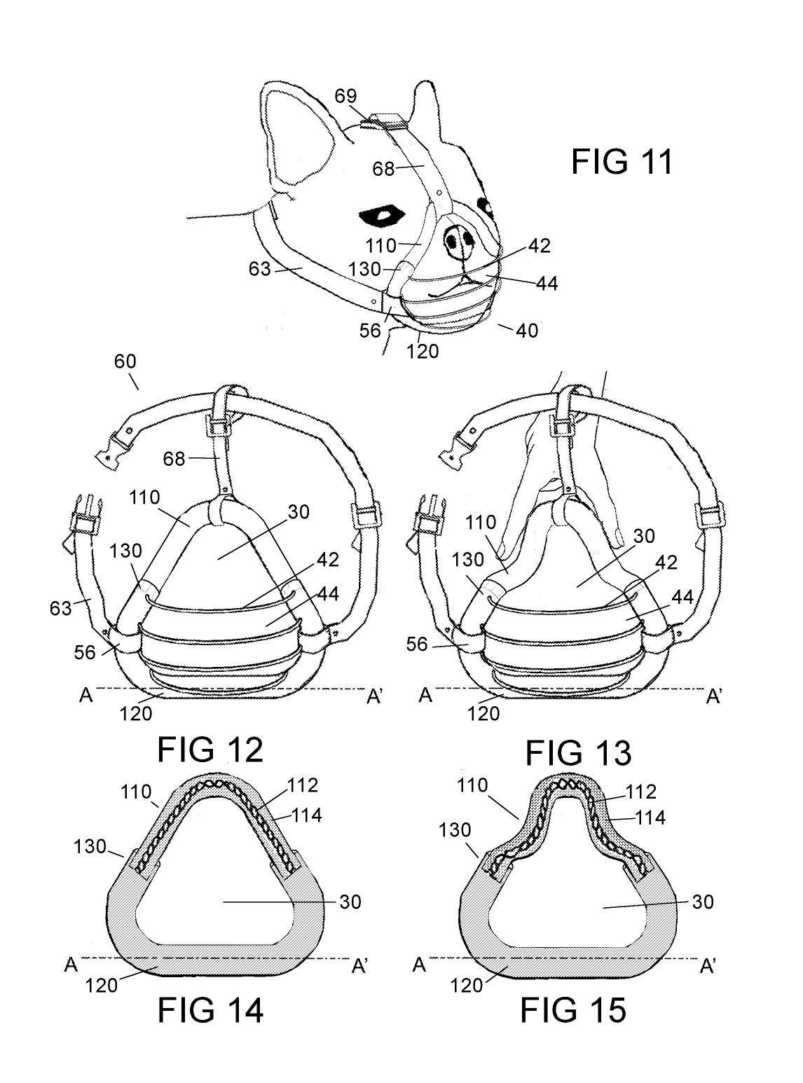

FIGS. 11-13 illustrate a third exemplary embodiment where frame 20 has a plurality of segments that comprise a deformable segment 110 and a rigid segment 120, and there is a convex shaped rigid cage frontal barrier 40 that covers at least a lower portion of frontal opening 30 to help prevent biting. Rigid segment 120 may be solid or hollow. FIGS. 14-15 illustrate in cross-section the interior along axis A-A′ of frame 20 for the embodiment shown in FIGS. 12 and 13. As shown deformable frame segment 110 comprises an inner deformable armature 112 that is covered by a pliable outer covering 114. Rigid frame segment 120 as shown is a rigid solid structure. However, in alternative embodiments rigid segment 120 may be entirely or partially hollow. Rigid segment 120 comprises rigid form structure which may be comprised of, by way of example and not limitation, silicone, poly vinyl chloride, polyurethane, metal, wood, natural rubber, etc. . . . .

As shown in FIGS. 6-15 it is contemplated that in embodiments of frame 20 that have a plurality of segments that the different segments of frame 20 shall be joined together, either fixedly or removably, at joints 130. To be removably joined means that after being joined together the segments may be separated non-destructively without significant damage to the joint 130, such that joint 130 may be reestablished between the same segments, or between one of the segments and a different segment. The ability to so separate joined segments can facilitate the replacement of segments in the frame which might have become dirty, worn or damaged, or it can facilitate the replacement of segments with other segments having different ornamental features (e.g. colors, designs, messages, etc.) or functional features (e.g. pliability, outer covering materials, halter attachment means, frontal barriers, etc.).

Techniques to removably join segments of frame 20 together may include, by way of example and not limitation: (i) Using a male-female threaded fastening technique where a first segment of frame 20 has a threaded recess at an end for receiving the end of a second adjacent segment of frame 20 that is threaded on the exterior and can be screwed into the threaded recess to form a joint; or (ii) using a threaded nut that can be screwed over the threaded exterior ends of adjacent frame segments of frame 20 to secure them together at a joint; or (iii) using a removable pin (e.g. a cotter pin) that can be passed through holes in the ends of adjacent segments of frame 20 which are aligned when the frame segment ends are brought together at a joint; or (iv) joining together segment ends using a quick connect fitting (such as for example a mender/splicer/joiner/union fitting adapter/coupler, socket joint, etc.). See also U.S. Pat. Nos. 7,452,006; 6,131,961; 6,672,792 the full contents of which are hereby incorporated by reference.

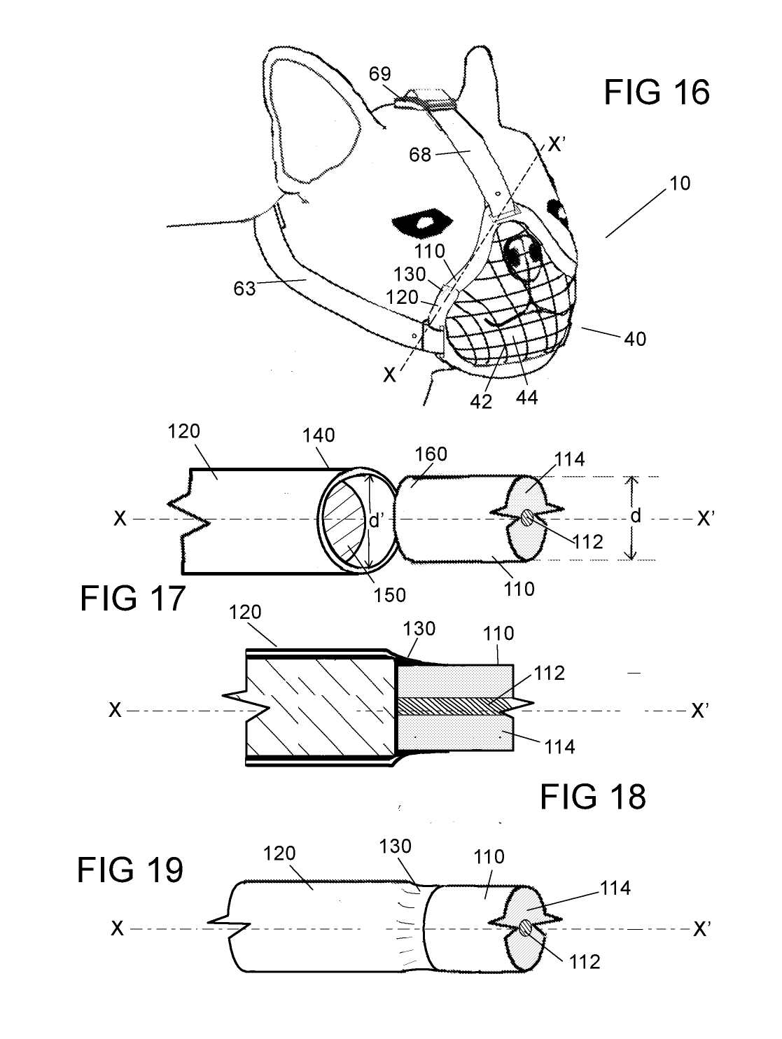

In other embodiments of the present invention where frame 20 is comprised of a plurality of segments it is contemplated that such segments may be fixedly joined to each other at one or more joints 130. To be fixedly joined means that the joint is intended to be permanent such that after being joined together the segments cannot readily be separated without physically damaging the joint 130. Referring to FIGS. 16-19, in a preferred exemplary embodiment segments of frame 20 are joined together using joints 130 that are crimped: In such an embodiment, joint 130 is formed between first segment 120 (i.e. the rigid segment) of frame 20 that has a joint recess 140 located at a female joint end 150. Joint recess 140 has an inner diameter d′. A male joint end 160 of the adjacent second segment 110 (i.e. the deformable segment) of frame 20 has an outer diameter d that is less than inner diameter d′. Male joint end 160 is combined with female joint end 150 by inserting male joint end 160 into joint recess 140. Once so combined heat and/or pressure are applied to the combination of female joint end 150 and male joint end 160 to form a joint 130 that is crimped. Crimped joint 130 fixedly joins first segment 120 to second segment 130. Other methods of fixedly joining segments of frame 20 may also be used including, by way of example and not limitation, use of adhesive bonding.

Frontal barrier 40 of the present invention serves the function of helping to prevent the animal from biting by creating at least a partial barrier between the animal's mouth and anything in front of the animal's face using one or more solid barrier elements 42. Solid barrier elements 42 may be comprised of any solid material, such as by way of example and not limitation metal thread, wire or rods; elastic cord; leather; fabric, plastic, rubber, elastomer, etc . . . .

It is contemplated that the frontal barrier 40 will cover at least in part or in whole frontal opening 30, but will always in preferred embodiments have at least one passageway 44 so that the animal (e.g. a cat or dog) can still breathe easily and even drink water since the at least one passageway 44 allows the passage of air and water through frontal barrier 40. Thus, as shown by way of example and not limitation in FIG. 1, a mesh frontal barrier 40 that covers the entire frontal opening 30 will have a plurality of passageways 44 between the interlaced solid barrier elements 42 allowing the passage of air and fluids through frontal barrier 40. Likewise, as shown by way of alternative example and not limitation in FIG. 6, a frontal barrier 40 that covers the entire frontal opening 30 may have a single central passageway 44 in single solid barrier element 42 that allows the passage of air and fluids through frontal barrier 40.

In the first exemplary embodiment of FIGS. 1-3 frontal barrier 40 is a pliable mesh structure consisting of a plurality of interlaced solid barrier elements 42 and a plurality of passageways 44 that pass through frontal barrier 40 between solid barrier elements 42. As stated above, the passageways 44 facilitate breathing and/or drinking by the animal. In this first exemplary embodiment of FIGS. 1-3 it is contemplated that the pliable mesh frontal barrier 40 will be comprised of a bendable and stretchable material (e.g. elastic cord) where solid barrier elements 42 can both bend and stretch in length to comfortably fit over and against the mouth and nose of the animal when the muzzle 10 is secured to the animal's head.

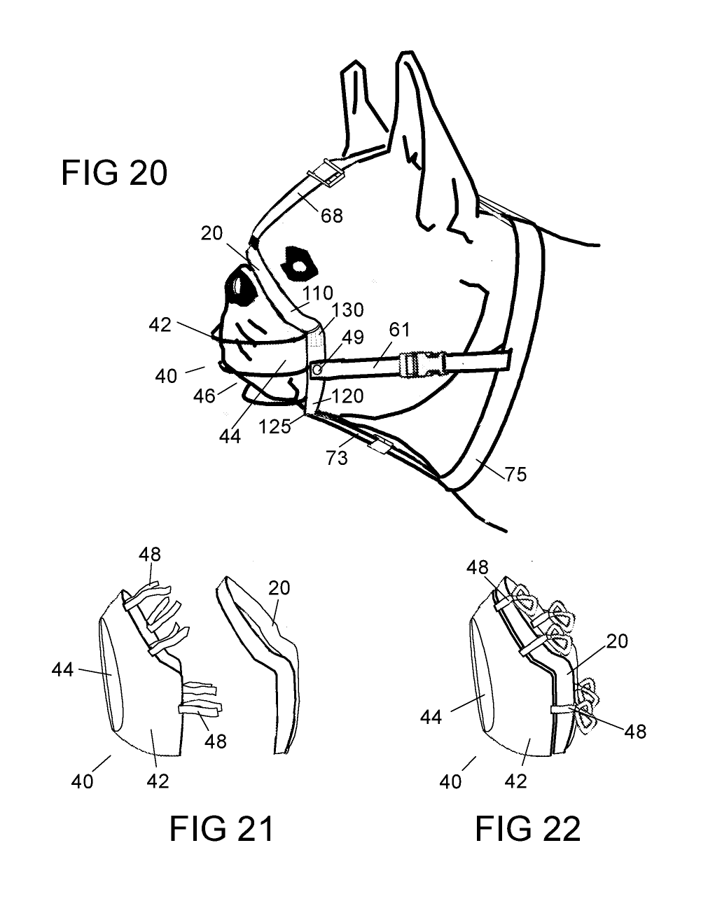

Referring to FIG. 16 in a variation of the bendable and stretchable mesh frontal barrier 40 embodiment of FIGS. 1 and 2 solid barrier elements 42 of frontal barrier 40 instead comprise a material that is bendable to facilitate shaping frame 20 to fit the animal's face but that is not able to stretch lengthwise (e.g. metal wire mesh). In such embodiments, it is contemplated that frontal barrier 40 will be given a convex shape extending outward from frame 20 such that a snout space 46 will exist behind frontal barrier 40 that can receive the animal's nose and mouth behind frontal barrier 40 when the muzzle 10 is placed onto the animal's head. See also FIG. 20.

In the second exemplary embodiment of frontal barrier 40 shown in FIGS. 6-8, solid barrier element 42 comprises a bendable and/or stretchable material (e.g. elastane fabric) that can both bend and stretch in length to comfortably fit over and against the mouth and nose of the animal when the muzzle 10 is secured to the animal's head, and that covers the entire frontal opening 30 except for a single passageway 44 in the frontal barrier 40. Passageway 44 in the exemplary embodiment of FIGS. 6-8 is positioned to provide a small opening over the animal's nose and a portion of the animal's mouth as shown in FIG. 6. Passageway 44 allows the passage of air and/or fluids to facilitate breathing and/or drinking by the animal. In this second exemplary embodiment, solid barrier element 42 may be comprised of any suitable fabric including, by way of example and not limitation, natural fibers (e.g. cotton) or man-made materials such as elastane (i.e. Lycra® or Spandex) stretch fabric. If the material used is bendable to facilitate shaping frame 20 to fit the animal's face but is not also stretchable it is contemplated that frontal barrier 40 will have a sufficient quantity of fabric material (i.e. slack) so that it can extend outward and away from frame 20 in a convex manner when the muzzle 10 is placed onto the animal's head and the animal's nose and mouth pass through frontal opening 30.

In the third exemplary embodiment shown in FIGS. 11-13, where the lower part of frame 20 is rigid segment 120, frontal barrier 40 is a rigid cage structure comprised of a plurality of rigid solid barrier elements 42 attached to rigid frame segment 120. The rigid solid barrier elements 42 form a cage over the lower portion of muzzle frame 20 to at least partially cover the animal's mouth to help prevent biting. Passageways 44 that are located between rigid solid barrier elements 42 allow the passage of air and/or fluids to facilitate breathing and/or drinking by the animal. Rigid solid barrier elements 42 may be comprised of any suitable rigid material including metal, wood, hard plastic, etc. . . .

It is contemplated that frontal barrier 40 may be either fixedly or removably attached to frame 20. Referring to FIGS. 1-3 and 6-8 by way of example and not limitation frontal barrier 40 may be fixedly attached to frame 20 by adhesive bonding, sewing, etc. . . . Referring to FIGS. 11-13 and FIG. 20 frontal barrier 40 may also comprise an extension (i.e. extrusion) of rigid frame segment 120: Thus, by way of example and not limitation, rigid segment 120 and the rigid cage structure frontal barrier 40 of FIGS. 11-13 and FIG. 20 may be a single molded piece.

Referring to FIGS. 21-22 it is contemplated that in some embodiments frontal barrier 40 may be removably attachable to deformable frame 20 to facilitate (i) the replacement of the frontal barrier 40 if it becomes dirty, worn or damaged; or (ii) to exchange frontal barriers 40 with other frontal barriers 40 that have different ornamental features (e.g. colors, designs, messages, etc. . . . ); or (iii) to exchange frontal barriers 40 with other frontal barriers 40 that have different functional features (e.g. pliability, materials, passageways, etc. . . . ). As shown, by way of example and not limitation, frontal barrier 40 may be removably attached to frame 20 by using one or more frontal barrier ties 48 (e.g. fabric or elastic cords, strips, or loops) that are attached to, or are a part of, frontal barrier 40 and that are used to tie the frontal barrier 40 onto the frame 20 (e.g. around frame 20 or to tie posts or tie holes that are located on or in frame 20). In alternative embodiments frontal barrier 40 may also use one or more mechanical fasteners along its outer edges such as a conventional snap that can be used to removably snap the frontal barrier 40 to frame 20.

Referring to FIGS. 1-3, it is contemplated that frame 20 will have a plurality of halter attachment locations 50 for facilitating attachment of a halter 60 to frame 20.

In the exemplary embodiment of FIG. 3 halter 60 comprises a neck strap 62 having (i) an adjustable length first cheek strap segment 61 with a cinch buckle 66 and first cheek strap segment attachment end 65, and (ii) an adjustable length second cheek strap segment 63 with a side release buckle 64 and a second cheek strap segment attachment end 67. The first cheek strap segment 61 may be removably fastened to the second cheek strap segment 63 with side release buckle 64. Halter 60 further comprises an adjustable length crown strap 68 with a cinch buckle 69 and crown strap attachment end 71. Crown strap 68 may be looped around and secured to neck strap 60 as shown using cinch buckle 69. The straps of halter 60 may be comprised of, by way of example and not limitation, nylon, fabric, elastane, or leather. Referring to FIG. 20 other halter configurations may also be used, including by way of example and not limitation, use of a lead strap 73 connected at one end to a chin portion 125 of muzzle frame 20 and the other end connected to a collar strap 75. See also U.S. Pat. No. 4,565,055 the complete contents of which are hereby fully incorporated by reference.

In a preferred contemplated embodiment illustrated herein halter 60 is fixedly attached to frame 20 by the first cheek strap segment attachment end 61, second cheek strap segment attachment end 67, and crown strap attachment end 71 through forming such attachment ends into attachment loops 56 on frame 20 at halter attachment locations 50: In an exemplary embodiment each attachment loop 56 may be permanently formed and secured to frame 20 by a rivet 52. In an alternative embodiment shown, by way of example and not limitation, in FIG. 20 halter 60 may be removably attached to frame 20 by using a mechanical fastener 49 like a snap to removably snap the halter onto frame 20. Alternatively, buckles (such as cinch or side release) may be used to create removable attachment loops 56.

In the exemplary embodiment of FIGS. 1-5 halter attachment locations 50 comprise holes in frame 20 through which the straps of halter 60 may pass through when being the halter is being attached to the frame. In an alternative embodiment of halter attachment locations may be any locations along frame 20 where the strap of halter 60 may be attached to frame 20. In the embodiment shown in FIGS. 6-10 halter attachment locations are locations along frame 20 where there are attachment loop passageways 54 through the solid barrier element 42 to facilitate placement of the attachment loops 56.

Referring by way of example to FIGS. 1-3, to attach the muzzle 10 of the present invention to an animal's head 200 a person (e.g. the animal's owner) manually deforms the deformable frame 20 so that frame 20 will conform to the shape of the animal's face 210 and will be well fitted to help prevent the animal from biting while preferably not covering the eyes 220 of the animal. Any deformable segment, or semi-rigid segment, may be manually deformed while the muzzle is in place over the animal's face 210. Alternatively, the animal owner may shape the deformable segment and/or any semi-rigid segment with the frame 20 away from the animal, place it onto the animal to test fit, and then remove to adjust further as needed until the desired fit is achieved. Once frame 20 has been deformed to the desired shape and been appropriately fitted to the animal's face the muzzle is then secured in place to the animal's head using a halter 60 that is attached to the muzzle frame.

The above description discloses several configurations of the present invention. This invention is susceptible to modifications in the configurations, as well as alterations in the manufacturing methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

1. An animal muzzle comprising:
a frame that is manually deformable;
a frontal opening bounded by said frame;
a frontal barrier having a solid frontal barrier element attached to said frame;
said frontal barrier covering at least a portion of said frontal opening.

2. The animal muzzle of claim 1 where said frontal barrier has at least one passageway.

3. The animal muzzle of claim 1 where said frontal barrier has a convex shape with a snout space behind said solid frontal barrier element.

4. The animal muzzle of claim 1 where said solid frontal barrier element is pliable.

5. The animal muzzle of claim 1 where said solid frontal barrier element is deformable.

6. The animal muzzle of claim 1 where said solid frontal barrier element is rigid.

7. The animal muzzle of claim 1 where said frame comprises an inner deformable armature and a pliable outer covering.

8. The animal muzzle of claim 7 where said inner deformable armature is comprised of metallic wire.

9. The animal muzzle of claim 7 where said pliable outer covering comprises an elastomer.

10. The animal muzzle of claim 1 where said frame comprises a plurality of segments.

11. The animal muzzle of claim 10 further comprising a deformable segment having a first deformability and a semi-rigid segment having a second deformability.

12. The animal muzzle of claim 10 further comprising a deformable segment and a rigid segment.

13. The animal muzzle of claim 10 further comprising a joint connecting one or more of said segments together.

14. The animal muzzle of claim 10 further comprising a segment that is removable from said frame.

15. The animal muzzle of claim 1 where said frontal barrier is removable from said frame.

16. The animal muzzle of claim 1 further comprising a halter attached to said frame.

17. The animal muzzle of claim 11 where said halter is removable from said frame.
